(19) United States
(12) Patent Application Publication
(10) Pub. No.: US 2013/0232023 A2
(43) Pub. Date: Sep. 5, 2013

(54) Systems and methods to process online monetary payments dependenton conditional triggers involving future events for online auctions and online trading exchanges involving stock exchange, commodity exchange, foreign exchange, sporting exchange, gaming exchange, file sharing exchange, andother types of online peer-to-peer exchange.

(71) Applicant: Randall Frank Muse, Poulsbo, WA (US)

(72) Inventor: Randall Frank Muse, Poulsbo, WA (US)

(21) Appl. No.: 13/572,636

(22) Filed: Aug. 11, 2012

(51) Int. Cl. G06Q 30/08

(52) U.S. Cl. 705/26.3

(57) ABSTRACT

The present invention is a system to process online monetary payments between end-users whose payments are dependent on conditional triggers involving future events, such as winning bids/offers in online auctions and online trading exchanges. These methods allow end-users of online auctions and online trading exchanges to send and receive payments directly to one another via online payment processors, without the online auction or online trading exchange becoming involved in payment collection. In the system, bids and offers are backed by actual funds held in reserve, or held in a queue, enabling instantaneous payments upon the close of an event. Thus, a user's winning bid instantly triggers a payment. The auction or trading exchange is not involved as a third party collector of funds, auction sellers avoids overdue, delinquent, and/or abandoned payments, and exchange traders receive instant account settlements. The system contains methods that become the basis for online payment processor applications, online auction software applications, and online trading exchange software applications. The system also contains methods that are to be included in standalone software applications or software application modules that interact with online payment processor applications, online auction software applications, and online trading exchange software applications. A trading exchange as defined in the system is either a stock exchange, commodity exchange, foreign exchange, sporting exchange, gaming exchange, file sharing exchange, or other generic form of online person-to-person exchange.

### CROSS-REFERENCE TO RELATED APPLICATIONS

This application claims the benefit of U.S. provisional application No. 61/522,807 filed Aug. 12, 2011.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### TECHNICAL FIELD

The invention has to do with electronic commerce, and the methods in which market participants send and receive payments using online payment processors. With regard to the invention, electronic commerce market participants will herein include banks, credit card firms, automated clearing houses, electronic currency transmitters, online payment processors, online auctions, online trading exchanges, stock exchanges, commodity exchanges, foreign exchanges, sporting exchanges, gaming exchanges, file sharing exchanges, other types of person-to-person exchanges, and end-user consumers.

### BACKGROUND

Network-based commerce systems have become prevalent in the online community, taking advantage of worldwide connectivity in order to bring together a large collection of market participants. Electronic commerce is conducted in the same fashion as regular commerce, except that buyers and sellers do not meet face to face.

E-commerce is conducted via an online storefront at the merchant's website. Numerous storefront versions have come into use. The first type is simply an extension of a brick-and-mortar-business such as Sears.com or walmart.com. The second type is any business that operates exclusively online. The third type uses a hosted seller platform, and charges a fee to sellers who want to use the website's selling platform. Third type examples include Half.com, Amazon.com and Craigslist.com. The fourth type includes online auctions such as e-Bay, online trading exchanges, stock exchanges, commodity exchanges, foreign exchanges, sporting exchanges, gaming exchanges, file sharing exchanges, and other types of person-to-person exchanges. The software used by the fourth type is usually more complex than that used with other types.

The development of e-commerce has produced various online payment processing techniques. The first set of techniques was brought about by banks and automated clearing house organizations. This includes credit card, debit card, electronic check, and bank person- to-person payments.

The second set includes two general methods. The first is payment via third party payment processors such as Paypal. A third party payment processor allows a buyer to purchase online without disclosing credit card or bank information. The second method is payment via an electronic currency such as Ven and Bitcoin. E-currency is similar to Paypal in that a consumer can make purchases online without disclosing credit card and bank information. Unlike Paypal, e-currency is similar to currencies backed by governments, and can be floated on trading exchanges. E-currency is the most cost effective payment method.

E-commerce has proven to be beneficial in the business world, bringing together buyers and sellers could not meet otherwise. The way payments are handled by online storefronts has proven to be problematic, however.

For example, online Payment processors provide ways consumers to make online transactions. At the same time they also act like banks, taking deposits and safeguarding them in individual accounts. This is convenient for the consumer, but also expensive. The costs come in several different forms. For example, most payment processors including Paypal, charge fees to the depositor for premium services such as faster deposits and withdrawls. Additionally, merchants linked to the payment processor must pay selling fees, which are similar to those of credit card services. These costs eventually reach consumers who pay higher prices for the goods they purchase online. What seems like free payment processor service is really a mask, behind which hides the higher prices charged by merchants. Another problem with online payment processors is that they provide no payment methods for time-based transactions, such as those found with online auctions and trading exchanges.

Other payment problems are found with the online auction. In this type of storefront, an item isn't bought or sold. The item is put up for auction, and must be won by a bidder. When the auction is over, the winner is legally binded to send payment to the seller. With most auctions this process can take as long as 14 days. [1] Many times a winner fails to complete the purchase at all, having found a cheaper price elsewhere. Studies reveal that winning bidders fail to make payment 10-15% of the time, and sellers fail to report 95% of the time. [2], [3]

Other payment problems have to do with online trading exchanges. There are six general types of trading exchanges: stock exchanges, commodity exchanges, foreign exchanges, sporting exchanges, gaming exchanges, and file sharing exchanges. For both brevity and clarity, the term “trading exchange” shall herein represent any of these six types.

Foreign exchange, or forex, is different in that it is conducted over-the-counter between two parties, rather than on a formal exchange. The advent of the Internet has given the opportunity for brokers and dealers to create online trading exchanges dealing in foreign exchange. These online foreign exchange websites have become the default destination for the individual trader, who normally wants to buy and sell very in small increments. Using an online exchange, a trader can lock in a price instantly without having to telephone a broker.

Whether a foreign exchange, stock exchange, or commodity exchange, the online exchange prevents a problem called “slippage” in which the broker quotes a price that changes before the actual trade is completed. Moreover, the online trading exchange is convenient for the user, enabling trading exchange access outside the regular broker work day and work week.

One fundamental problem for traders who deal with stock, forex, and commodity trading exchanges is the fees they pay to the broker/dealer for the opportunity to make a trade. The broker/dealer is not providing access to any formal exchange, but nonetheless charges a fee to both open and close a trade. The broker/dealer price simply mirrors the current bid or offer at a large formal trading exchange. Thus, the broker/dealer merely provides access to a website where the user can find prices which are duplications of that of a large formal exchange. Thus, a payment problem exists where online exchange traders pay exorbitant fees in order to make trades. These fees are more aptly described as a tax, since little or no service is provided by the dealer/broker.

A payment problem can also be found with online sporting exchanges in which bids/offers are made regarding the outcome of sporting events, horse races, etc. These exchanges are similar to sports book operations, except that a user can become either the bidder or offeror, and thus no bookie is required to set the odds for an event. Unlike forex, commodity, and stock exchanges, bid/offer prices in sporting exchanges can be influenced by average size trades of a small investor. Like forex, sporting exchanges are not regulated by any one governing body, and subscribe to a unique set of rules and fee structures, depending on what part of the world they are in.

The first payment problem with online sporting exchanges has to do with the fact that operating a sports trading exchange is illegal in some areas, while legal in others. In the U.S. for example, online horse race betting is legal, while online sports betting is illegal. Additionally, horse betting exchanges were legalized in California and New Jersey, but remain illegal elsewhere in the U.S. Thus, in some areas there are no legal business operators, forcing the consumer to deal with offshore operations with limited or no regulation. Dealing with an offshore business is costly due to the time and money it takes to send funds back and forth. It is also confusing for the consumer who must do business according to the rules of other cultures with different languages, time zones, and business customs. Moreover, when there is a dispute, or a company goes out of business, the consumer is left with little or no recourse. Additionally, due to murky interpretations of U.S. law, many sporting exchanges in Europe have chosen not to offer services to U.S. based users.

A payment problem is found with online gaming exchanges as well. Online gaming, or skill gaming, has become prevalent in the online community. Users meet online at gaming websites and either play head-to-head with each other, or participate in a tournament. Some of the most popular are poker websites, which are faced with the same legality status as sporting exchanges. Thousands of other types of games are played online, some of which are considered legal and others illegal. Moreover, there are fees involved to participate. Most gaming websites charge a fee to convert money into credits. Fees sometimes can be as much as 30%, as in the case of Facebook.com.

A payment problem is also found with file sharing exchanges. Music file sharing dates back to 1999 when Napster first came online. Napster gave its members the ability to share digital music files with one another. Soon after, other online ventures utilizing open source file sharing applications appeared, such as Gnutella and FastTrack. All of these services allow members to download files located on a designated area of another member's computer. The software that runs the service matches up two members on the network, one of whom queries the network for a song or album title. When the query finds a match, two computers are connected, and a copy of the file is transferred via HTTP or another electronic protocol. These networks initially became very popular, with millions of people trading files back and forth. Network members were able to open up their entire music collections to the network, and expect the same from others. Some services also allowed movie and software files to be offered over the network. However, several major record labels filed suit, causing Napster to be shut down in 2001.

File sharing continued to be a growing phenomenon, nonetheless. Over the next 12 years, the growth of the industry evolved, with three noteworthy trends becoming key. The first was the continuation of file sharing over decentralized file sharing networks using the open source application, Gnutella. The second was the proliferation of Bit Torrent networks which spread file sharing to a new level of popularity due to their anonymity. The third was the abandonment of digital music encryption technology (Digital rights management—or DRM) by several major record labels and online music firms. As a result, file sharing today is conducted in various formats and environments. Bit Torrent and Gnutella based services remain popular, despite the efforts of U.S. Federal government and the Motion Picture Association of America's attempt to ban and/or shut down some of the major players in the field. Today's consumer is nonetheless faced with the quasi legal status of file sharing, and file sharing networks that often contain corrupted and/or virus laden files.

Firms such as Rhapsody and Kazaa employ a subscription-based service in which members pay a monthly fee, and are granted access to listen to any music they wish via streaming media. Members, however, cannot download files and thus are never granted ownership of the music content. This business model is inherently flawed since music content is easily recorded while listened to. Consequently, many of these firms supplement their business model by also selling downloads encrypted with DRM.

Many online services do not offer streaming media subscriptions, solely focusing on selling downloaded content. Moreover, the major players in the field including Itunes, Amazon, Yahoo, and Emusic have stopped using DRM altogether for most of their music downloads. Without DRM, digital content owners are able to make backup copies and transfer them to any computer or storage device they wish.

Looking at the various file sharing networks and business models brings up the question: What does digital content ownership involve? The major attribute of digital content is that it is easily copied and distributed via the Internet. This is evident by the proliferation of music file sharing networks. But these networks make files available in such a way that creates a market system with no accountability. A user can download files, not knowing where or from whom they came from. Distributing music over these types of networks is like creating a virtual copy of an entire record label's library, and offering it anonymously to anyone. The initial reaction of the record labels was predictable.

Because free file sharing networks have remained popular, major record labels and online music services have ceased policing the ownership rights of digital content by removing the DRM encryption. However, free file sharing networks are not fully accepted by governments, and are mistrusted by both artists and users. Most people are comfortable with traditional markets which feature less anonymity than file sharing networks, and produce more accountability as to who the market participants are, and what is being traded. With file sharing, accountability is found only when content is traded on a one-to-one basis, and where the participants are known to each other. Thus far, prevailing methods of trading digital content do not resemble those of traditional trading markets.

### BRIEF SUMMARY OF THE INVENTION

The above described problems associated with online payments are all different, but have a similar thread running through them. That is, payment problems could be solved by methods that allow payments to flow freely between buyer and seller, but also be flexible enough to allow for conditional events in which time, and/or a specific result is a factor.

The first method takes place at the payment processor level using application software. The application allows consumers to send and receive payments automatically, via available online payment processors on the market, and allows payments to be made conditional on events, such as winning bids in online auctions and online trading exchanges. The application allows payments to be made via an online payment processor, directly between an end-user and one or more other end-users, with each bid/offer to be backed by a real fund, held in reserve, or each bid/offer to be held in a queue. In this way, a winning bid triggers an instantaneous payment at the close of the auction or trading event.

Other methods take place at the website of the merchant and/or with the consumer's web browser via a stand-alone software application. These other methods either complement or replace methods at the payment processor level.

The payment problems associated with online payment processors are solved in two ways. Those problems associated with time-based transactions in auctions and trading exchanges are solved by requiring the payment processor to infuse the bidding process with the payment process software. In the system, a winning bid instantly triggers a payment to the seller or offeror. Auctions and trading exchanges are not involved as a third party collectors of funds, and sellers avoids overdue, delinquent, and/or abandoned payments and/or account resolutions.

Problems associated with fees are solved in two separate ways. One way is via the time-based method above, where auctions and trading exchanges are not involved as a third party collectors of funds. This inherently produces lower prices for the consumer because sellers avoid paying merchant fees to the payment processor. In the system, online payment processors function as they do now, except they enable time-based transactions and produce lower costs for merchants, buyers, and sellers. The second way fees can be lowered is by eliminating costs the online payment processor incurs by taking customer deposits, and holding funds in individual accounts. This can be achieved by having the online payment processor act as a middle operator between the consumer and banking institutions. The online payment processor in this case can process time-based transactions while linked to customer accounts within banks and other money transmitting firms.

The payment problems with online auctions are solved by requiring the auction software to infuse the bidding process with financial banking, where a winning bid instantly triggers a payment. The auction is not involved as a third party collector of funds, and the seller avoids overdue, delinquent, and/or abandoned payments.

The payment problems with online trading exchanges are solved in much the same way as online auctions, by requiring the trading exchange software to infuse bidding with financial banking, so that a winning bid instantly triggers a payment. The trading exchange is not involved as a third party collector of funds, and market participants enjoy instant account settlement at minimal cost. In doing so, a trading exchange can operate without actually accepting deposits, leaving the payment collection to the end-users themselves. Furthermore, by using advertising or other means for website monetization, a trading exchange can offer fee free trading. Such a trading exchange is free to conduct business in places previously prohibited. This improves the situation for consumers by providing safer, more efficient, and cost effective trading.

The payment problem involving digital content could also be solved in a similar manner as that of online auctions. Digital content containing no DRM encryption is similar to any other marketable item. The owner is free to sell or otherwise offer it in a trade. However, when transferring digital content, accountability must be assigned by requiring the user to trade digital content files only on a one-to-one basis. In the system, users designate a list of files they are looking for from other members. Before trading, users are required to register with the service so that network members are known to each other, and can be supervised by network administrators. Trades are instantly processed once a user chooses a file to exchange. Corrupted and virus laden files are easily traced back to the owner, creating accountability and increasing the quality of the content being traded. The system creates a formal marketplace for one-to-one trading with accountability and quality assurance.

### Current State of the Technology

The online payment processor, Paypal, features two innovative payment concepts with their Direct payment and Express Checkout. These programs allow merchants to authorize and capture payments directly from either the merchant website or the Paypal website. They simplify the process of using Paypal, but don't solve the payment problems described thus far. The online auction company E-bay has considered creating an automatic payment service to complement their regular auctions and facilitate easier payments. [4] However, what they are considering will make them a collector of funds, which is the business model of a traditional store rather than an auction service. The added business costs necessary for incorporating traditional store features into their service will only serve to create higher fees for auction bidders and sellers.

E-bay currently uses a payment concept called buy-it-now. This allows an auction consumer to pay a stated price for an item, and purchase it immediately. This concept complements the auction process, but is not infused with it. The buy-it-now feature creates a transaction which resembles a regular online store purchase, not correlated in any way with an online auction process.

Therefore, what is needed is a system and method(s) that allows payments to flow freely between buyer and seller, but also be flexible enough to allow for conditional events over time. At the payment processor level, the system allows consumers to send and receive payments that are conditional, based on events such as a winning bid in an online auction or online trading exchange. At either the merchant website and/or the client-level of the user's web browser, the system allows each bid/offer to be backed by a real fund, held in reserve, or each bid/offer to be held in a queue. A winning bid instantly triggers a payment. The auction or trading exchange is not involved as a third party collector of funds, and the auction seller avoids overdue, delinquent, and/or abandoned payments.

### SUMMARY OF EMBODIMENTS THE INVENTION

In one embodiment of the invention, a system and method(s) processes online payments. The software program is a standalone online payment processor application. The method allows consumers to send and receive payments directly on a one-to-one basis, and allows payments to be made conditional on events, such as winning bids in auctions and trading exchanges. The application allows each bid/offer to be backed by a real fund, held in reserve, or each bid/offer to be held in a queue.

In another embodiment of the invention, a system and method(s) interacts with traditional online payment processors, either as a plug-in software module or standalone software application. The application allows consumers to send and receive payments directly on a one-to-one basis, via available bank person-to-person or debit/credit card online payment processors on the market, as well as allow payments to be made conditional on events, such as winning bids in auctions and trading exchanges. The application allows each bid/offer to be backed by a real fund, held in reserve, or each bid/offer to be held in a queue.

In another embodiment of the invention, a system and method(s) interacts with traditional online payment processors, either as a plug-in software module or standalone software application. The application allows consumers to send and receive payments directly on a one-to-one basis, via available automated clearing house online payment processors on the market, as well as allow payments to be made conditional on events, such as winning bids in auctions and trading exchanges. The application allows each bid/offer to be backed by a real fund, held in reserve, or each bid/offer to be held in a queue.

In another embodiment of the invention, a system and method(s) interacts with traditional online payment processors, either as a plug-in software module or standalone software application. The application allows consumers to send and receive payments directly on a one-to-one basis, via available e-currency online payment processors on the market, as well as allow payments to be made conditional on events, such as winning bids in auctions and trading exchanges. The application allows each bid/offer to be backed by a real fund, held in reserve, or each bid/offer to be held in a queue.

In another embodiment of the invention, a system and method(s) is an online auction software application that infuses the bidding process with bank person-to-person or debit/credit card online payment processors, automated clearing house online payment processors, and e-currency online payment processors. The application allows consumers to send and receive payments directly on a one-to-one basis via online payment processors. The application allows each bid/offer to be backed by a real fund, held in reserve.

In another embodiment of the invention, a system and method(s) interacts with traditional online auctions, either as a plug-in software module or stand-alone software application. The application allows consumers to send and receive payments directly on a one-to-one basis via bank person-to-person or debit/credit card online payment processors. The software infuses the bidding process with bank person-to-person or debit/credit card online payment processors, allowing each bid or offer to be backed by a real fund, held in reserve.

In another embodiment of the invention, a system and method(s) interacts with traditional online auctions, either as a plug-in software module or stand-alone software application. The application allows consumers to send and receive payments directly on a one-to-one basis via automated clearing house online payment processors. The software infuses the bidding process with automated clearing house payment processors, allowing each bid or offer to be backed by a real fund, held in reserve.

In another embodiment of the invention, a system and method(s) interacts with traditional online auctions, either as a plug-in software module or stand-alone software application. The application allows consumers to send and receive payments directly on a one-to-one basis via e-currency online payment processors. The software infuses the bidding process with e-currency online payment processors, allowing each bid or offer to be backed by a real fund, held in reserve.

In another embodiment of the invention, a system and method(s) is an online auction software application that infuses the bidding process with bank person-to-person or debit/credit card online payment processors, automated clearing house online payment processors, and e-currency online payment processors. The application allows consumers to send and receive payments directly on a one-to-one basis. The application allows each bid/offer to be held in a queue.

In another embodiment of the invention, a system and method(s) interacts with traditional online auctions, either as a plug-in software module or stand-alone software application. The application allows consumers to send and receive payments directly on a one-to-one basis user via bank person-to-person or debit/credit card online payment processors. The software infuses the bidding process with bank person-to-person or debit/credit card online payment processors, allowing each bid/offer to be held in a queue.

In another embodiment of the invention, a system and method(s) interacts with traditional online auctions, either as a plug-in software module or stand-alone software application. The application allows consumers to send and receive payments directly on a one-to-one basis user via automated clearing house online payment processors. The software infuses the bidding process with automated clearing house payment processors, allowing each bid/offer to be held in a queue.

In another embodiment of the invention, a system and method(s) interacts with traditional online auctions, either as a plug-in software module or stand-alone software application. The application allows consumers to send and receive payments directly on a one-to-one basis user via e-currency online payment processors. The software infuses the bidding process with e-currency payment processors, allowing each bid/offer to be held in a queue.

In another embodiment of the invention, a system and method(s) is an online trading exchange software application which infuses the bidding process with bank person-to-person or debit/credit card online payment processors, automated clearing house online payment processors, and e-currency online payment processors. The application allows consumers to send and receive payments directly on a one-to-one basis via online payment processors, where each bid/offer is held in a queue.

In another embodiment of the invention, a system and method(s) interacts with traditional online trading exchanges, either as a plug-in software module or stand alone software application. The application allows consumers to send and receive payments directly on a one-to-one basis via bank person-to-person or debit/credit card online payment processors. The software infuses the bidding process with bank person-to-person or debit/credit card payment processors, where each bid/offer is held in a queue.

In another embodiment of the invention, a system and method(s) interacts with traditional online trading exchanges, either as a plug-in software module or stand alone software application. The application allows consumers to send and receive payments directly on a one-to-one basis user via automated clearing house online payment processors. The software infuses the bidding process with automated clearing house payment processors, where each bid/offer is held in a queue.

In another embodiment of the invention, a system and method(s) interacts with traditional online trading exchanges, either as a plug-in software module or stand alone software application. The application allows consumers to send and receive payments directly on a one-to-one basis user. The software infuses the bidding process with e-currency payment processors, where each bid/offer is held in a queue.

In another embodiment of the invention, a system and method(s) is an online trading exchange software application which infuses the bidding process with bank person-to-person or debit/credit card online payment processors, automated clearing house online payment processors, and e-currency online payment processors. The application allows consumers to send and receive payments directly on a one-to-one basis via any online payment processor, where each bid/offer is backed by a real fund, held in reserve.

In another embodiment of the invention, a system and method(s) interacts with traditional online trading exchanges, either as a plug-in software module or stand alone software application. The application allows consumers to send and receive payments directly on a one-to-one basis user via bank person-to-person or debit/credit card online payment processors. The software infuses the bidding process with bank person-to-person or debit/credit card payment processors, where each bid/offer is backed by a real fund, held in reserve.

In another embodiment of the invention, a system and method(s) interacts with traditional online trading exchanges, either as a plug-in software module or stand alone software application. The application allows consumers to send and receive payments directly on a one-to-one basis user via automated clearing house online payment processors. The software infuses the bidding process with automated clearing house payment processors, where each bid/offer is backed by a real fund, held in reserve.

In another embodiment of the invention, a system and method(s) interacts with traditional online trading exchanges, either as a plug-in software module or stand alone software application. The application allows consumers to send and receive payments directly on a one-to-one basis via e-currency online payment processors. The software infuses the bidding process with e-currency payment processors, where each bid/offer is backed by a real fund, held in reserve.

For all embodiments, matching bids/offers instantly trigger payments, eliminating the need for the online auction or online trading exchange to act as a third party collector of funds.

For all online trading exchange embodiments, bid/offer matches involving a time and/or event variant, such as a binary forex index or sporting match, instantly trigger payments as well. In this case, however, payments from both the bid and offer parties are sent to temporary funds on client-side applications residing either at each party's computer, the payment processor, or designated storage locations accessible by both parties and the payment processor. The funds are unavailable to either party until the close of the event. Upon the determination of a winning side, a payment is instantly triggered, reversing the original payment made by the winning bid/offer party.

Using any of the above embodiments, a trading exchange can operate without accepting deposits, leaving the payment collection to the end-users themselves. Furthermore, by using advertising or other means for website monetization, a trading exchange can offer fee free trading.

### BRIEF DESCRIPTION OF THE DRAWINGS

FIG. 1A is a diagram depicting the relationships between the online auction, online payment network entity, and consumer(s), that otherwise make up one online auction payments environment for the invention.

FIG. 1B is a diagram depicting the relationships between the online auction, online payment network entity, and consumer(s), that otherwise make up one online auction payments environment for the invention, showing how the relationships work together using a reserve bid method.

FIG. 1C is a diagram depicting the relationships between the online trading exchange, independent data sources, online payment network entity, and consumer(s), that otherwise make up one online trading exchange payments environment for the invention.

FIG. 1D is a diagram depicting the relationships between the online trading exchange, independent data sources, online payment network entity, and consumer(s), that otherwise make up one online trading exchange payments environment for the invention, showing how the relationships work together using a reserve bid method.

FIG. 1E is a diagram depicting the relationships between the online auction, online payment network entity, and consumer(s), that otherwise make up one online auction payments environment for the invention, showing how the relationships work together using a queue bid method.

FIG. 1F is a diagram depicting the relationships between the online trading exchange, independent data sources, online payment network entity, and consumer(s), that otherwise make up one online trading exchange payments environment for the invention, showing how the relationships work together using a queue bid method.

FIG. 2A is a flow chart illustrating a system and methods that allows for a bid or offer in an online trading exchange to be backed by an actual fund in the amount of the bid or offer, with this fund to be held in reserve by an online payment network until the end of a time-based marketplace event. (e.g., binary trade, betting event)

FIG. 2B is a flow chart illustrating a system and methods that allows for a bid in an online auction be backed by an actual fund in the amount of the bid, with this fund to be held in reserve by an online payment network until the end of the auction.

FIG. 2C is a flow chart illustrating a system and methods that allows each bid/offer in an online auction to be held in a queue. A payment is instantly triggered from the party with the highest bid in the queue. If this transaction fails, a payment is instantly triggered from the party with the next highest bid in the queue. This process continues until a successful payment is made, as long as the bid in question is over a predetermined reserve amount.

FIG. 2D is a flow chart illustrating a system and methods that allows for a bid or offer in an online trading exchange to be held in a queue. When a bid and an offer together form a match, the online payment network is set to trigger a payment upon the end of the time-based marketplace event in question. (e.g., binary index time trade, betting event)

FIG. 3A is a flow chart illustrating a method where an online auction sends an encrypted bid code to an online payment network. The bid code is used to reserve funds in the amount of the bid.

FIG. 3B is a flow chart illustrating a method where an online trading exchange sends an encrypted code to an online payment network. The code is used to reserve funds in the amount of the bid or offer.

FIG. 3C is a flow chart illustrating a method where an online auction sends an encrypted bid code to an online payment network. The bid code is used to hold the bid amount in a queue.

FIG. 3D is a flow chart illustrating a method where an online trading exchange sends an encrypted code to an online payment network. The code is used to hold the bid or offer amount in a queue.

FIG. 4 is a flow chart illustrating a method which recognizes when a user has increased the bid for an auction. The method gives the bid a unique code that is sent to the online payment network encrypted with a digital certificate, canceling the earlier fund reserve, and replacing it with a new fund reserve.

FIG. 4B is a flow chart illustrating a method which recognizes when a user has increased the bid for an auction. The method gives the bid a unique code that is sent to the online payment network encrypted with a digital certificate, canceling the earlier bid, and placing the new, higher bid in the bid queue.

FIG. 5A is a flow chart illustrating a method that, once a winning bidder is determined by the online auction, sends a transaction code and the user's online payment network ID to the online payment network, encrypted with a digital certificate, causing the winning bidder's reserved fund to be credited to the seller's account with the online payment network, and also causing all other reserved funds from other bidders in the auction to be canceled, and credited back to their respective accounts.

FIG. 5B is a flow chart illustrating a method that, once a winner is determined by the online trading exchange, sends an auction code to the online payment network, encrypted with a digital certificate, causing the losing trader's reserved funds to be credited to the winning trader's account with the online payment network.

FIG. 5E is a flow chart illustrating a method that, once a winning bidder is determined by the online auction, sends a transaction code and the user's online payment network ID to the online payment network, encrypted with a digital certificate, causing a payment to be instantly triggered from the account with the highest bid in the queue.

FIG. 5F is a flow chart illustrating a method that, once a winning bidder is determined by the online trading exchange, sends a transaction code and the user's online payment network ID to the online payment network, encrypted with a digital certificate, causing a payment to be instantly triggered from the account of the matching queued bid, or losing bid/offer.

FIG. 6 A is a diagram depicting the relationships between an online auction or online trading exchange, an online payment network entity, a consumer(s), and a stand-alone software application, which resides either at the client-side computer of an online auction or online trading exchange user, the payment processor, or designated storage locations, and which interacts with an online payment processor and/or an online auction or online trading exchange and/or end-users of an online auction or online trading exchange, that make up a stand-alone software application/entity environment for the invention.

FIG. 6B is a diagram depicting the relationships between an online auction or online trading exchange, an online payment network entity, a consumer(s), and a stand-alone software application, which resides at the server-side computer of a third-party online payments service provider, which interacts with an online payment processor and/or an online auction or online trading exchange and/or end-users of an online auction or online trading exchange, that make up a stand-alone software application/entity environment for the invention.

FIG. 6C is a diagram depicting the relationships between an online auction or online trading exchange, an online payment network entity, a consumer(s), and a software module, which resides at the server-side computer of an online auction or online trading exchange, which interacts with an online payment processor and/or an online auction or online trading exchange and/or end-users of an online auction or online trading exchange, that make up a module/entity environment for the invention.

FIG. 6D is a diagram depicting the relationships between an online auction or online trading exchange, an online payment network entity, a consumer(s), and a software module, which resides at the server-side computer of an online payment processor, which interacts with an online payment processor and/or an online auction or online trading exchange and/or end-users of an online auction or online trading exchange, that make up a module/entity environment for the invention.

### DETAILED DESCRIPTION

This description is described to enable any person skilled in the art to make and use the invention, and is shown here with the knowledge that various changes to the disclosed embodiments will be apparent to those skilled in the art, and that these changes do not supersede the scope of the invention as depicted herein. Thus, the invention is not intended to be limited to the embodiments shown, but is to be given the widest scope parallel to the systems and methods illustrated herein.

It should be understood that the invention could be utilized within various versions of what is considered a computer system. (e.g., Desktop, Laptop computer, Mobile phone, etc) Specifics of how these machines work (e.g., Display, calculation, memory) are not presented for the purpose of brevity and clarity.

### The E-Commerce System

For all embodiments, an online payment network is equivalent to an online payment processor, with or without a software module or stand-alone software application which interacts with either an online payment processor and/or an online auction or online trading exchange and/or end-users of an online auction or online trading exchange.

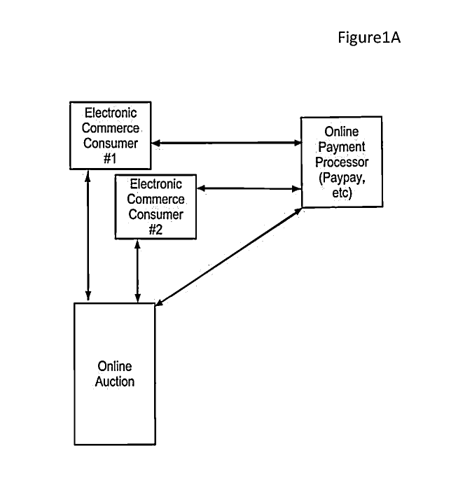

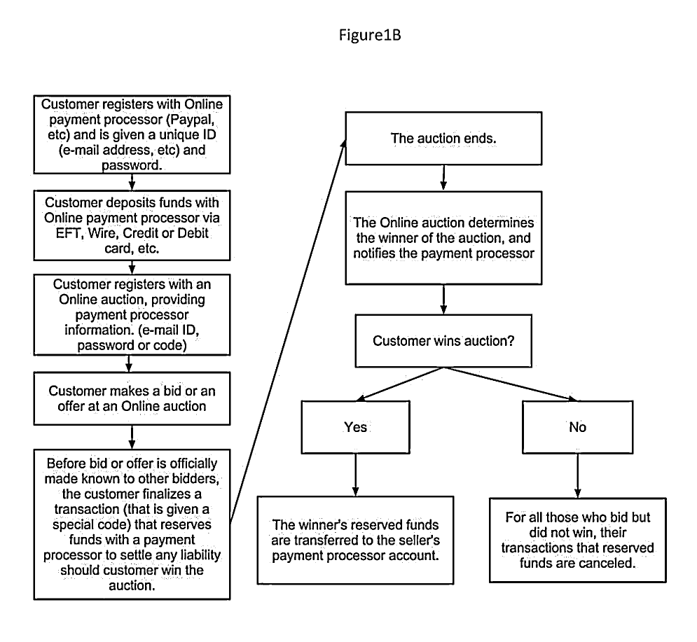

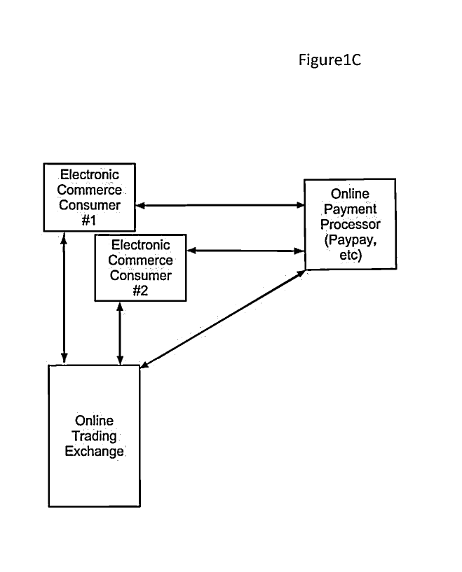

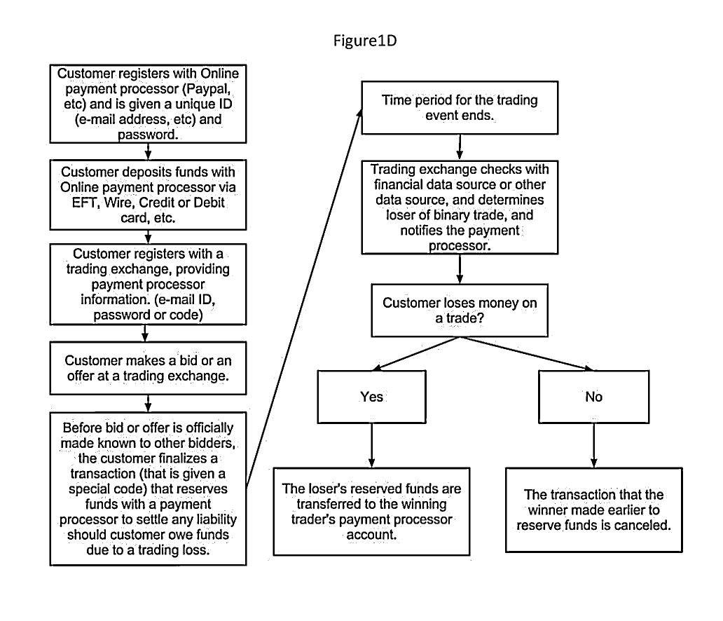

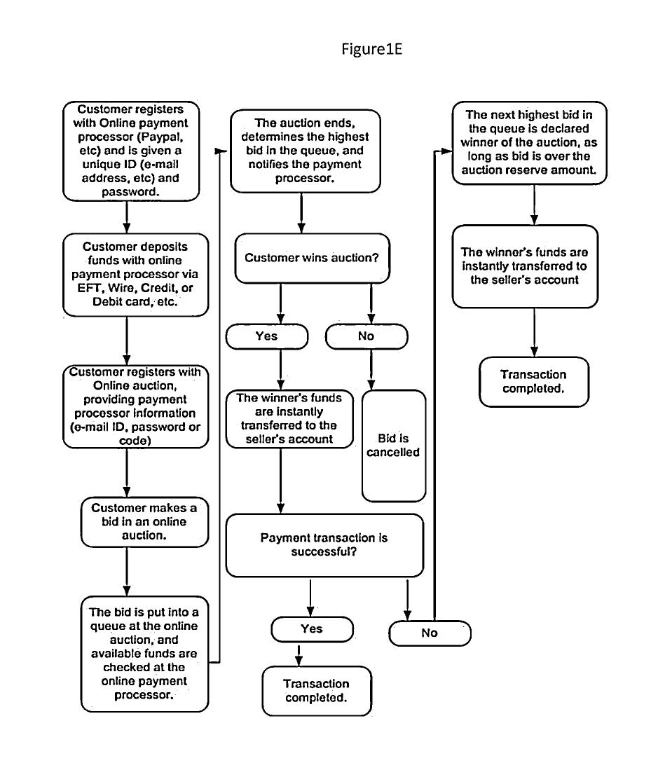

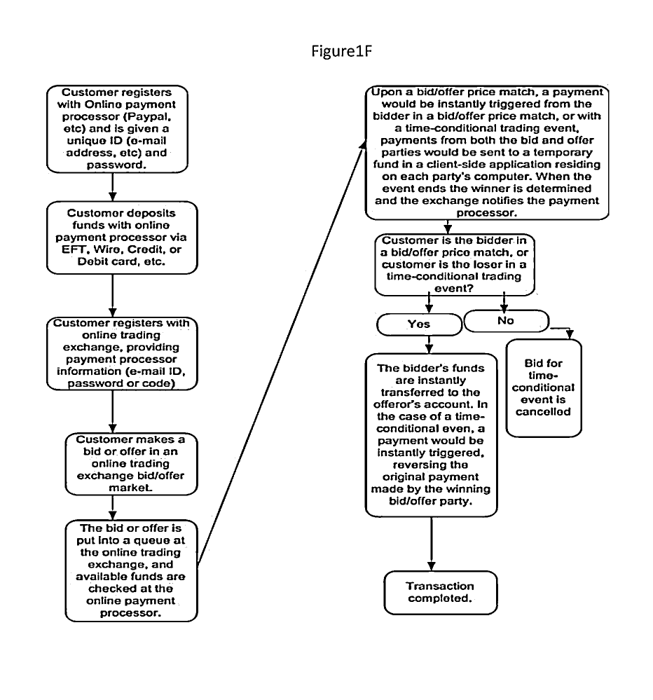

FIG. 1A is a diagram depicting the relationships between the online auction, online payment network entity, and consumer(s), that otherwise make up the relationship environment between entities for the invention.

In one embodiment, (FIG. 1B) the consumer accesses an online auction via the Internet and registers to be a user. The consumer then accesses an online payment processor via the Internet, registers to be a user, and deposits funds to the account. The online auction accesses the services of the online payment processor using the online payment processor's API program procedures. These procedures allow users of an online auction to reserve funds in order to cover their most recent bid. When an auction ends, a program procedure, using an API call, cancels all reserved funds held for the accounts of those with losing bids, making those funds available again to the user. An API program procedure using an API call then takes the reserved funds of the winning bidder, and sends it as payment to the seller's account.

Using this system, sellers at the online auction receive payment directly upon the close of an auction, greatly accelerating and streamlining the auction payment process. Instead of the seller waiting for up to 14 days, payments are received instantly. The seller also avoids abandoned payments where the winner of an auction fails to complete the purchase.

FIG. 1C is a diagram depicting the relationships between the online trading exchange, independent data sources, online payment network entity, and consumer(s), that otherwise make up the relationship environment between entities for the invention.

In another embodiment, (FIG. 1D) the consumer accesses the online trading exchange via the Internet and registers to be a user of the online trading exchange. The consumer then accesses an online payment processor via the Internet, registers to be a user, and deposits funds to the account. The online trading exchange accesses the services of the online payment processor using the online payment processor's API program procedures. These procedures allow users of an online trading exchange to reserve funds in order to cover their most recent bid/offer. At the end of the online trading exchange bid/offer time-conditional event, a program procedure, using an API call, cancels all reserved funds held for the accounts of those with winning bid/offers, making those funds available again to the user. Funds reserved for events that are not time-conditional, such as a spot forex index, can always be canceled at the user's discretion should the user decide to exit a market position. In an open-ended-conditional event, such as a stock, commodity, or forex market, an API program procedure then uses an API call to send the reserved funds from the bidder of the bid/offer price match, to the offeror of the bid/offer price match. In a time-conditional event market, an API program procedure then uses an API call to send the reserved funds from the account of the event loser from the bid/offer price match, to the account of the event winner from the bid/offer price match.

In another embodiment, (FIG. 1E) the consumer accesses an online auction via the Internet and registers to be a user. The consumer then accesses an online payment processor via the Internet, registers to be a user, and deposits funds to the account. The online auction accesses the services of the online payment processor using the online payment processor's API program procedures. The application allows each bid/offer to be held in a queue. Upon the end of an auction, a payment is instantly triggered from the party with the highest bid in the queue. If this transaction fails due to insufficient funds, a payment is instantly triggered from the party with the next highest bid in the queue. This process continues until a successful payment is made. If there is a predetermined reserve amount for the auction, no payment will be processed if the winning bid fails to meet the reserve amount.

Using this system, sellers at the online auction receive payment directly upon the closing of an auction, greatly accelerating and streamlining the auction payment process. Instead of the seller waiting for up to 14 days, payments are received instantly. The seller also avoids abandoned payments where the winner of an auction fails to complete the purchase.

In another embodiment, (FIG. 1F) the consumer accesses an online trading exchange via the Internet and registers to be a user. The consumer then accesses an online payment processor via the Internet, registers to be a user, and deposits funds to the account. The online trading exchange accesses the services of the online payment processor using the online payment processor's API program procedures. The application allows each bid/offer to be held in a queue, instead of funds being explicitly reserved. Upon a bid/offer price match, a payment is instantly triggered from the bidder in a bid/offer price match. If this transaction fails due to unavailable funds, the match is canceled, and the bid is canceled. Bid/offer matches involving a time variant such as a binary forex index or sporting match, instantly trigger payments as well. In this case, however, payments from both the bid and offer parties are sent to temporary funds on client-side applications residing either with each party's computer, the payment processor, or designated storage locations accessible by both parties and the payment processor. Each fund is unavailable to either party as well as the payment processor, until the end of the event. At the close of the event, a payment is instantly triggered, reversing the original payment made by the winning bid/offer party. The original payment sent by the losing party is then summarily collected by the winning party.

When an online trading exchange is a sporting exchange, it is possible for a trading event to have multiple entrants, such as with horse racing, auto racing, and golf tournaments. In these cases, a user can offer prices to buyers for multiple entrants of an event. A user who offers prices for multiple entrants can expect to receive payments from multiple bidders whose entrants lose in the event. For example, a user can offer a price on 5 different cars competing in an auto race. If none of the 5 cars win the race, the offeror receives 5 different payments from 5 different buyers. In such a scenario, a program procedure using an API call, takes either the matched reserved funds or matched queue funds from every buyer whose entrant loses in the event, and sends it as payment to the winning offeror's account.

Using any of the above embodiments, a trading exchange can operate in the same country as it's users, and do so without accepting deposits, leaving the payment collection to the end-users themselves. Furthermore, by using advertising or other means for website monetization, a trading exchange can offer fee free trading, with the consumer gaining safer, more efficient and cost effective trading.

### The Online Payment Network API

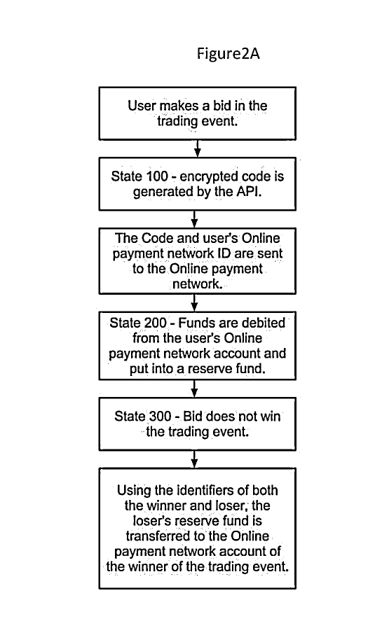

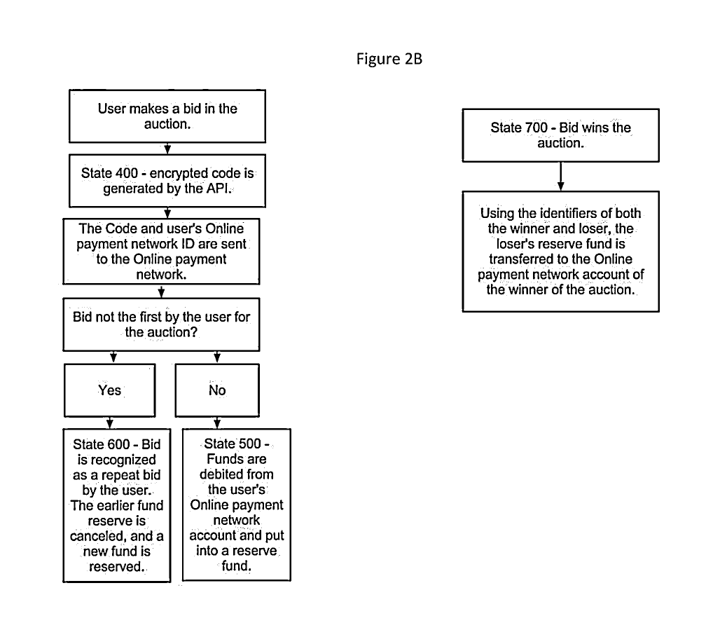

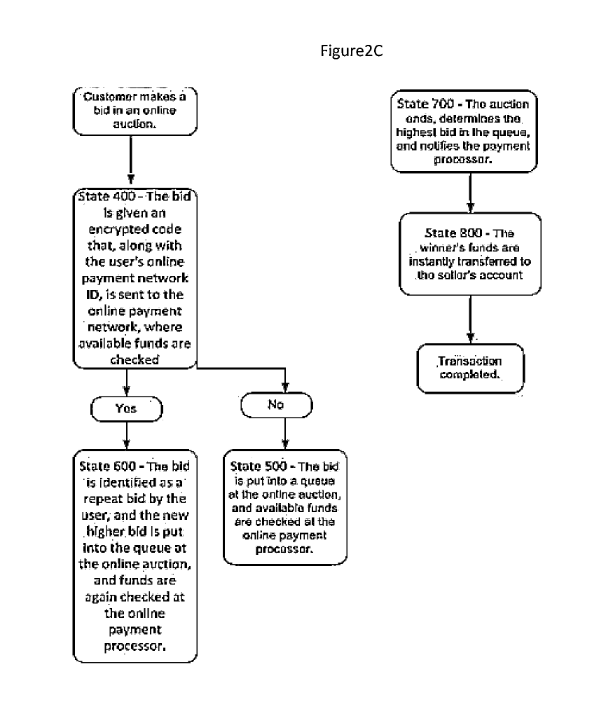

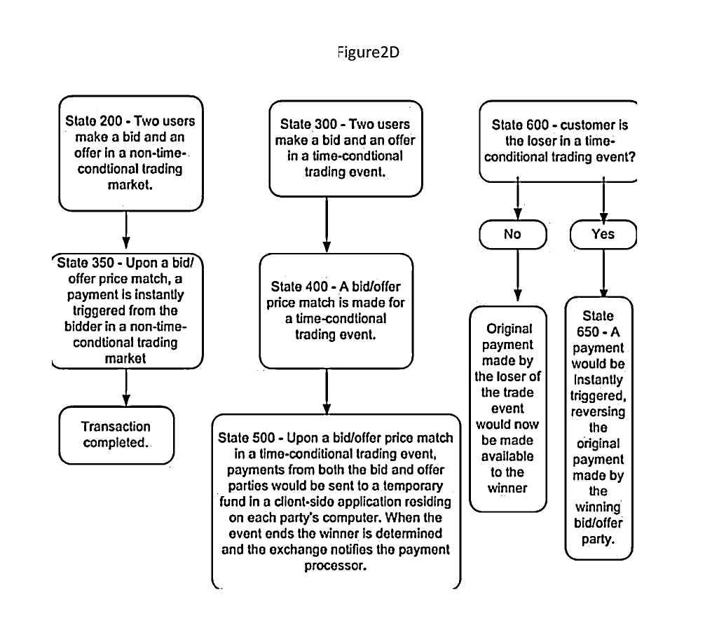

FIG. 2A is a flow chart illustrating a system and methods that allows for a bid or offer in an online trading exchange to be backed by an actual fund in the amount of the bid or offer, with this fund to be held in reserve by an online payment network until either a bid/offer price match triggers a payment in an open-ended-conditional event for a stock, commodity, forex, or file sharing market, or a bid/offer price match triggers a payment upon the end of a time-based marketplace event. (e.g., binary trade, betting event)

In this embodiment, (FIG. 2A) the system itself is a computer program that allows the online trading exchange user to access an online payment network via the online trading exchange website, thus allowing for reserve funds to be associated with bids and offers as they are made by the users of the online trading exchange.

The program uses digital certificates to authenticate a transaction each time the user makes a bid or offer, reserving funds in the user's account with an online payment network in the amount of the bid or offer. In State 100, the bid is given an encrypted code that, along with the user's online payment network ID, is sent to the online payment network. In State 200, a reserve fund is generated using the two identifiers. In State 300, the bid ends up losing, with the two identifiers used to generate a payment to the winner of the trade event.

FIG. 2B is a flow chart illustrating a system and methods that allows for a bid in an online auction to be backed by an actual fund in the amount of the bid, with this fund to be held in reserve by an online payment network until the end of the auction.

In this embodiment, (FIG. 2B) the system itself is a computer program that allows the auction user to access an online payment network via the online auction website, thus allowing for reserve funds to be associated with bids as they are made by the users of an online auction.

The program uses digital certificates to authenticate a transaction each time the user makes a bid, reserving funds in the user's account with an online payment network in the amount of the bid. In State 400, the bid is given an encrypted code that, along with the user's online payment network ID, is sent to the online payment network. In State 500, a reserve fund is generated using the two identifiers. In State 600, the bid is identified as a repeat bid by the user, with the earlier reserved fund being replaced by a new reserved fund. In State 700, the auction closes and the bid ends up winning, with the two identifiers being used to generate a payment to the seller. An optional feature enables an additional reserve fund to be made, reflecting only the increase from the previous bid.

FIG. 2C is a flow chart illustrating a system and methods that allows each bid/offer in an online auction to be held in a queue. Upon the end of the auction a payment is instantly triggered from the party with the highest bid in the queue. If this transaction fails, a payment is instantly triggered from the party with the next highest bid in the queue. This process continues until a successful payment is made. If there is a predetermined reserve amount for the auction, no payment will be processed if the winning bid fails to meet the reserve amount.

In this embodiment, (FIG. 2C) the system itself is a computer program that allows the auction user to access an online payment network via the online auction website, thus allowing for an automatic payment to be associated with the highest bid of an online auction. In state 200 a bid is made by the user. In State 400, the bid is given an encrypted code that, along with the user's online payment network ID, is sent to the online payment network, where available funds are checked. In state 500, the bid is put into a queue at the online auction. In State 600, the bid is identified as a repeat bid by the user, and the new higher bid is put into the queue at the online auction, and funds are again checked at the online payment processor. In State 700 the bid ends up winning, with the bid and offer party identifiers used in State 800 to generate a payment from the buyer to the seller of the auction.

FIG. 2D is a flow chart illustrating a system and methods that allows for a bid or offer in an online trading exchange to be held in a queue. When a bid and an offer together form a match in an open-ended-conditional event for a stock, commodity, forex, or file sharing market, a payment is immediately triggered. In a time-conditional event, the online payment network is set to trigger a payment upon the end of the time-based marketplace event in question. (e.g., binary index time trade, betting event)

In this embodiment, (FIG. 2D) the system itself is a computer program that allows the trading exchange user to access an online payment network via the online trading exchange website, thus allowing for an automatic payment to be associated with a bid/offer match between users of an online trading exchange. In state 200 a bid and an offer are made in an open-ended-conditional trade event, and put into a queue at the trading exchange. In state 300 a bid and an offer are made in a time-conditional trade event, and put into a queue at the trading exchange. In state 350 a bid/offer price match is made and a payment is instantly triggered from the bidder to the offeror in the open-ended-conditional event. In state 400 the bid and offer form a price match in a time-conditional bid/offer event. In State 500, payments are instantly triggered from both bid and offer parties, to a client-side holding module located at both the bid and offer party's computers, the payment processor, or designated storage locations accessible by both parties and the payment processor. In state 600, the bid ends up losing, with the bid and offer party identifiers used to generate a reverse payment to the winner of the trade event in State 650.

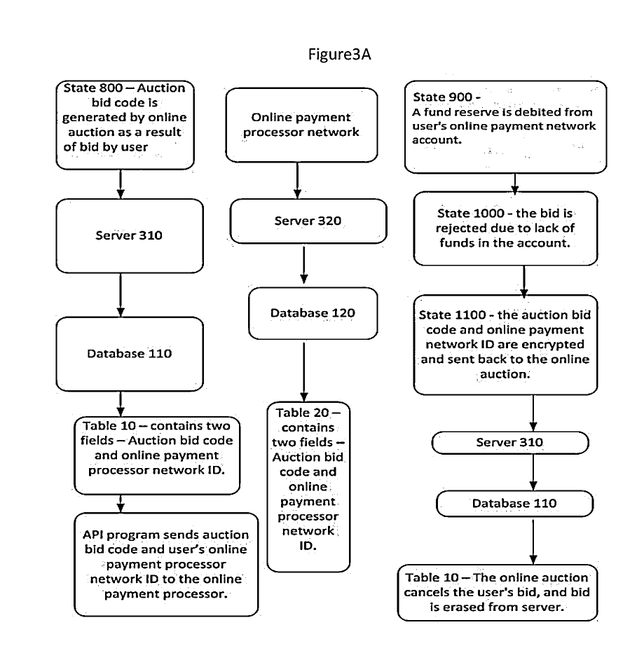

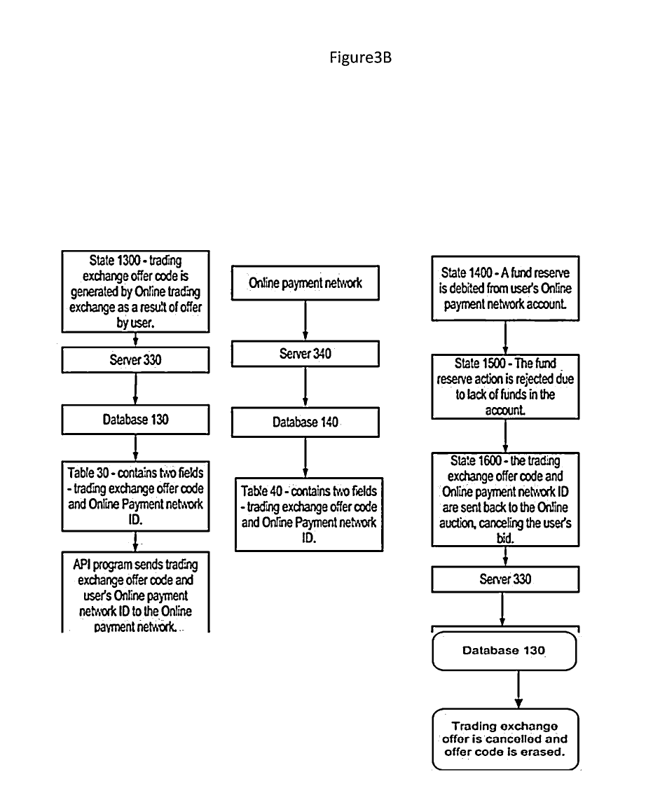

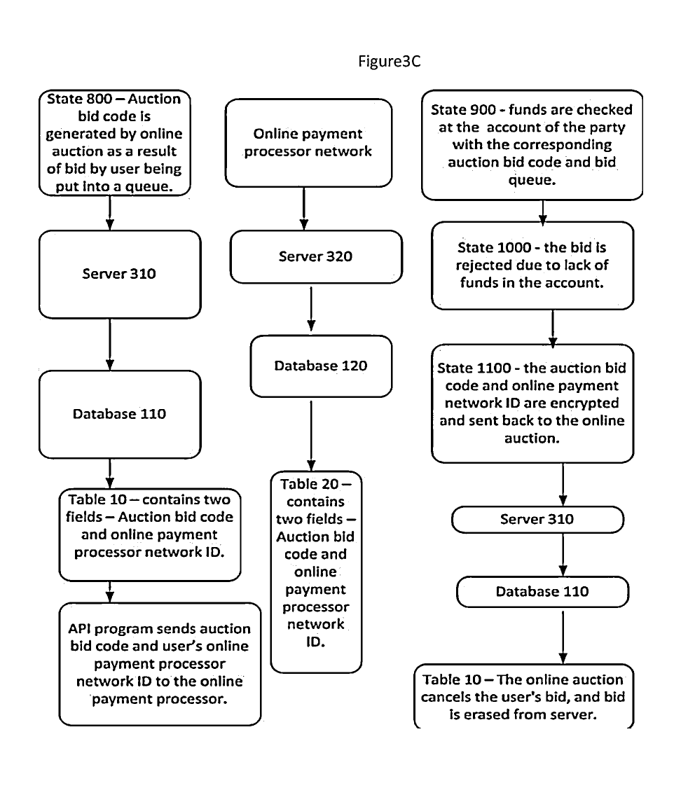

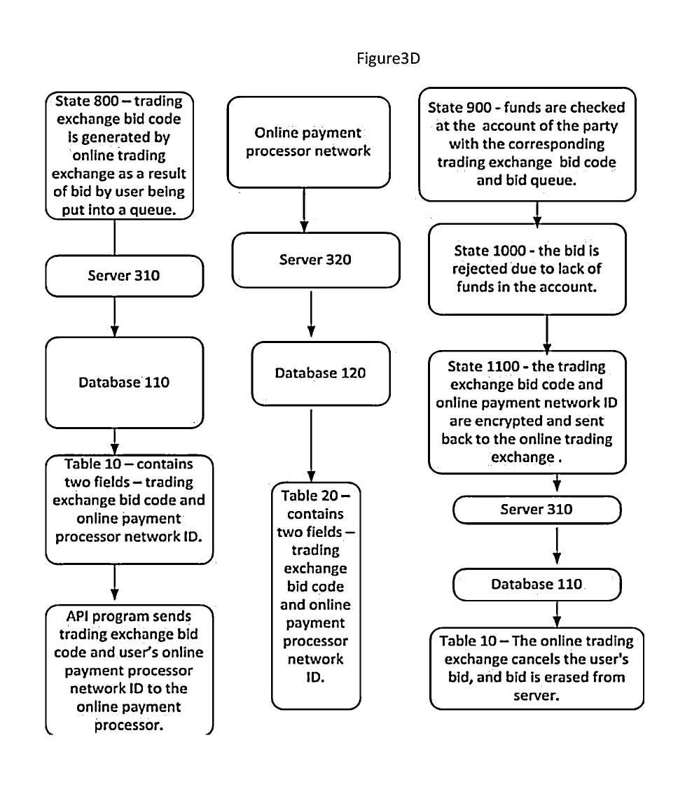

FIG. 3A is a flow chart illustrating a method where an online auction sends an encrypted bid code to an online payment network. The bid code is used to reserve funds in the amount of the bid.

In this embodiment, (FIG. 3A) an auction bid code (State 800) is generated as a result of an auction bid by a user, and put into Table 10 of Database 110 via the online auction's back-end server. (Server 310) The auction bid code and the user's online payment network ID are then encrypted and sent to the online payment network by a program procedure using an API call, where it is put into Table 20 of Database 120 by the online payment network's back-end server. (Server 320) In State 900, a fund is reserved using the auction bid code, with this amount being debited from the user's account. In State 1000, the reserving of funds is rejected due to lack of funds in the account. In State 1100, the auction bid code and online payment network ID are encrypted and sent back to the online auction. The online auction then cancels the user's bid. The bid is then erased from Table 10 of Database 110 by the online auction's back-end server. (Server 310)

FIG. 3B is a flow chart illustrating a method where an online trading exchange sends an encrypted code to an online payment network. The code is used to reserve funds in the amount of the bid or offer.

In this embodiment, (FIG. 3B) a trading exchange offer code (State 1300) is generated as a result of a trading exchange offer by a user, and put into Table 30 of Database 130 via the online trading exchange's back-end server. (Server 330) The trading exchange offer code and the user's online payment network ID are then encrypted and sent to the online payment network by a program procedure using an API call, where it is put into Table 40 of Database 140 by the online payment network's back-end server. (Server 340) In State 1400, a fund is reserved using the trading exchange offer code, with this amount being debited from the user's account. In State 1500, the reserving of funds is rejected due to lack of funds in the account. In State 1600, the trading exchange offer code and online payment network ID are encrypted and sent back to the online trading exchange. The online trading exchange then cancels the user's offer. The offer code is then erased from Table 30 of Database 130 by the online trading exchange's back-end server. (Server 330)

FIG. 3C is a flow chart illustrating a method where an online auction sends an encrypted bid code to an online payment network. The bid code is used to hold the bid amount in a queue.

In this embodiment, (FIG. 3C) an auction bid code (State 800) is generated as a result of an auction bid by a user, and put into Table 10 of Database 110 via the online auction's back-end server. (Server 310) The auction bid code and the user's online payment network ID are then encrypted and sent to the online payment processor network by a program procedure using an API call, where it is put into Table 20 of Database 120 by the online payment network's back-end server. (Server 320) In State 900, account funds are checked for the amount of the auction bid code. In State 1000, the bid is rejected due to lack of funds in the account. In State 1100, the auction bid code and online payment network ID are encrypted and sent back to the online auction. The online auction then cancels the user's bid. The bid is then erased from Table 10 of Database 110 by the online auction's back-end server. (Server 310) In the interest of clearing the queue of unsubstantiated bids, an optional feature entails that for each bid, funds in the associated account are initially checked and then checked 3 times during last 24 hours of the auction, including during the last hour, and before final payment.

FIG. 3D is a flow chart illustrating a method where an online trading exchange sends an encrypted code to an online payment network. The code is used to hold the bid or offer amount in a queue.

In this embodiment, (FIG. 3D) a trading exchange bid code (State 800) is generated as a result of an trading exchange bid by a user, and put into Table 10 of Database 110 via the online trading exchange's back-end server. (Server 310) The trading exchange bid code and the user's online payment network ID are then encrypted and sent to the online payment network by a program procedure using an API call, where it is put into Table 20 of Database 120 by the online payment network's back-end server. (Server 320) In State 900, account funds are checked for the amount of the trading exchange bid code. In State 1000, the bid is rejected due to lack of funds in the account. In State 1100, the trading exchange bid code and online payment network ID are encrypted and sent back to the online trading exchange. The online trading exchange then cancels the user's bid. The bid is then erased from Table 10 of Database 110 by the online trading exchange's back-end server. (Server 310) In the interest of clearing the queue of unsubstantiated bids, an optional feature entails that for each bid, funds in the associated account are initially checked and then checked 3 times during last 24 hours of a time-conditional trading exchange bid/offer event, including during the last hour, and before final payment. Funds associated with an open-ended-conditional trading exchange bid/offer market are checked every 20 minutes.

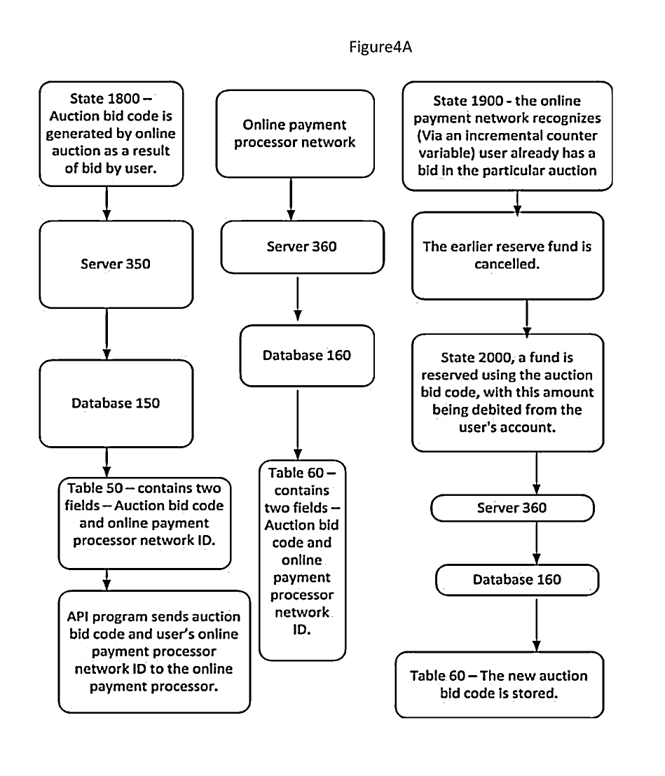

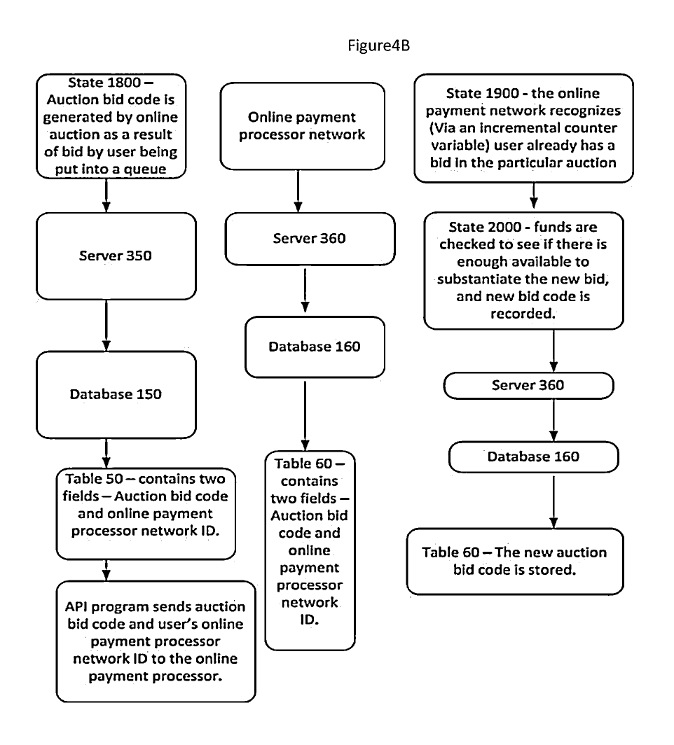

FIG. 4 is a flow chart illustrating a method which recognizes when a user has increased the bid for an auction. The method gives the bid a unique code that is sent to the online payment network encrypted with a digital certificate, canceling the earlier fund reserve, and replacing it with a new fund reserve.

In this embodiment, (FIG. 4) an auction bid code (State 1800) is generated as a result of an auction bid by a user, and put into Table 50 of Database 150 via the online auction's back-end server. (Server 350) The auction bid code and the user's online payment network ID are then encrypted and sent to the online payment network by a program procedure using an API call, where it is put into Table 60 of Database 160 by the online payment network's back-end server. (Server 360) In State 1900, the online payment network recognizes (Via an incremental counter variable) that the user already has a reserve for the particular auction, and cancels the earlier reserve fund. In State 2000, a fund is reserved using the auction bid code, with this amount being debited from the user's account. The auction bid code is then erased from Table 60 of Database 160 by the online payment network's back-end server. (Server 360) An optional feature enables an additional reserve fund to be made, reflecting only the increase from the previous bid.

FIG. 4B is a flow chart illustrating a method which recognizes when a user has increased the bid for an auction. The method gives the bid a unique code that is sent to the online payment network encrypted with a digital certificate, canceling the earlier bid, and placing the new, higher bid in the bid queue.

In this embodiment, (FIG. 4B) an auction bid code (State 1800) is generated as a result of an auction bid by a user, and put into Table 50 of Database 150 via the online auction's back-end server. (Server 350) The online auction recognizes that it is not the user's first bid, and updates the queue to replace the earlier bid with the latest bid. The auction bid code and the user's online payment network ID are then encrypted and sent to the online payment network by a program procedure using an API call, where it is put into Table 60 of Database 160 by the online payment network's back-end server. (Server 360) This bid code can then be used by the auction site for checking to see that funds are available to substantiate bids. In State 1900, the online payment network recognizes (Via an incremental counter variable) that the user already has made a bid for the particular auction, and cancels this bid code. In State 2000, funds are checked to see if there are funds available to substantiate the new bid, and a new bid code is recorded. The old auction bid code is then erased from Table 60 of Database 160 by the online payment network's back-end server. (Server 360)

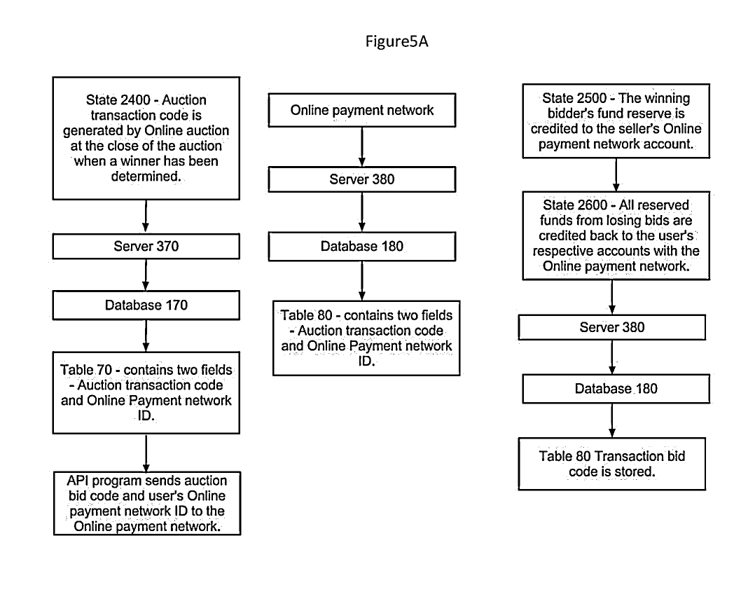

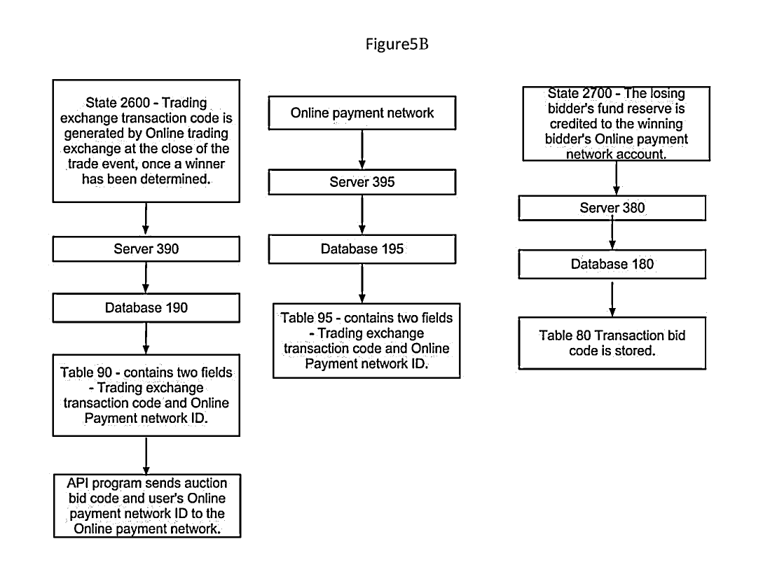

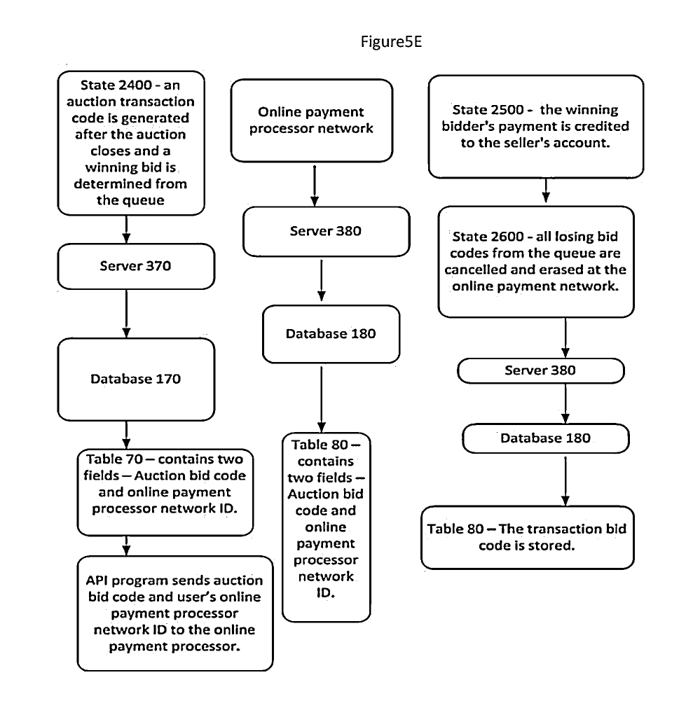

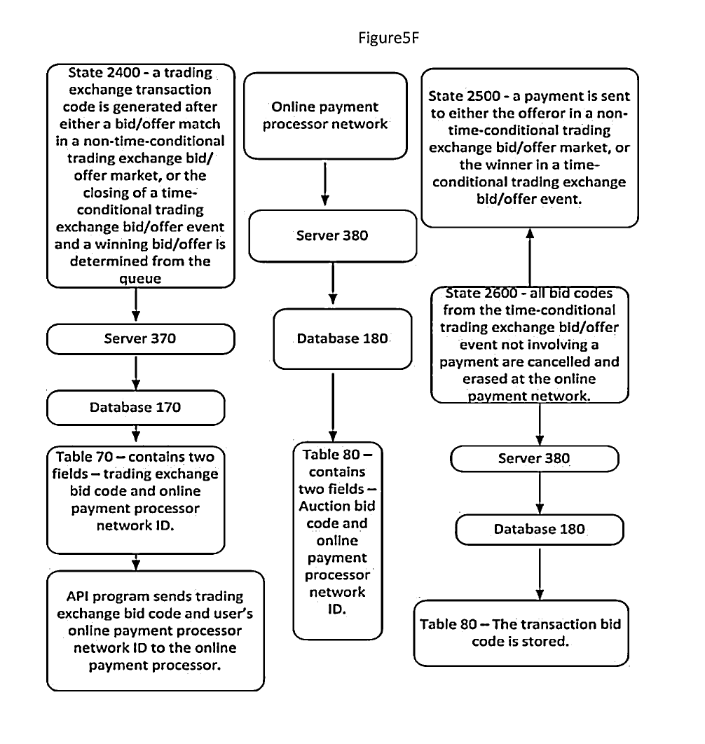

FIG. 5A is a flow chart illustrating a method which, once a winning bidder is determined by the online auction, sends a transaction code and the user's online payment network ID to the online payment network, encrypted with a digital certificate, causing the winning bidder's reserved fund to be credited to the seller's account with the online payment network, and also causing all other reserved funds from other bidders in the auction to be canceled, and credited back to their respective accounts.

In this embodiment, (FIG. 5A) an auction transaction code (State 2400) is generated after the auction closes and a winning bid is determined, and put into Table 70 of Database 170 via the online auction's back-end server. (Server 370) The transaction code and the users online payment network ID are then encrypted and sent to the online payment network by the API program, where it is put into Table 80 of Database 180 by the online payment network's back-end server. (Server 380) In State 2500, the winning bidder's reserved fund is credited to the seller's account. In State 2600, all reserved funds from losing bids associated with the auction are credited back to the user's account with the online payment network. The transaction bid code is then stored in Table 80 of Database 180 by the online payment network's back-end server. (Server 380)

FIG. 5B is a flow chart illustrating a method that, once a winner is determined by the online trading exchange, sends a transaction code to the online payment network, encrypted with a digital certificate, causing a losing trader's reserved funds to be credited to the winning trader's account with the online payment network.

In this embodiment, (FIG. 5B) a trading exchange transaction code (State 2600) is generated after the trading event is over and the trading event winner is determined, and put into Table 90 of Database 190 via the online trading exchange's back-end server. (Server 390) The transaction code and the users online payment network ID are then encrypted and sent to the online payment network by the API program, where it is put into Table 95 of Database 195 by the online payment network's back-end server. (Server 395) In State 2700, the losing trader's reserved fund is credited to the winning trader's account. The transaction bid code is then stored in Table 80 of Database 180 by the online payment network's back-end server. (Server 380)

FIG. 5E is a flow chart illustrating a method that, once a winning bidder is determined by the online auction, sends a transaction code and the user's online payment network ID to the online payment network, encrypted with a digital certificate, causing a payment to be instantly triggered from the party with the highest bid in the queue.

In this embodiment, (FIG. 5E) an auction transaction code (State 2400) is generated after the auction closes and a winning bid is determined, and put into Table 70 of Database 170 via the online auction's back-end server. (Server 370) The transaction code and the users online payment network ID are then encrypted and sent to the online payment network by the API program, where it is put into Table 80 of Database 180 by the online payment network's back-end server. (Server 380) In State 2500, the winning bidder's payment is credited to the seller's account. In State 2600, all losing bid codes are canceled and erased at the online payment network. The transaction bid code is then stored in Table 80 of Database 180 by the online payment network's back-end server. (Server 380) In the interest of clearing the queue of unsubstantiated bids, an optional feature entails that for each bid, funds in the associated account are initially checked and then checked 3 times during last 24 hours of the auction, including during the last hour, and before final payment.

FIG. 5F is a flow chart illustrating a method that, once a winning bidder is determined by the online trading exchange, sends a transaction code and the user's online payment network ID to the online payment network, encrypted with a digital certificate, causing a payment to be instantly triggered from the account of the matching queued bid, or losing bid/offer.

In this embodiment, (FIG. 5F) a trading exchange transaction code (State 2400) is generated after either a bid/offer match in an open-ended-conditional trading exchange bid/offer market, or the closing of a time-conditional trading exchange bid/offer event and a winning bid/offer is determined, and put into table 70 of Database 170 via the online trading exchange's back-end server. (Server 370) The transaction code and the users online payment network ID are then encrypted and sent to the online payment network by the API program, where it is put into Table 80 of Database 180 by the online payment network's back-end server. (Server 380) In State 2500, a payment is sent to either the offeror in an open-ended-conditional trading exchange bid/offer market, or the winner in a time-conditional trading exchange bid/offer event. In State 2600, all bid codes from the time-conditional trading exchange bid/offer event not involving a payment are canceled and erased at the online payment network. The transaction bid code is then stored in Table 80 of Database 180 by the online payment network's back-end server. (Server 380) In the interest of clearing the queue of unsubstantiated bids, an optional feature entails that for each bid, funds in the associated account are initially checked and then checked 3 times during last 24 hours of a time-conditional trading exchange bid/offer event, including during the last hour, and before final payment. Funds associated with an open-ended-conditional trading exchange bid/offer market are checked every 20 minutes.

For all embodiments, it is optional to allow bids/offers and payments to be encrypted using digital certificates in order to authenticate each bid/offer and payment transaction.

For all embodiments, matching bids/offers instantly trigger payments, eliminating the need for the online auction or online trading exchange to act as a third party collector of funds.

For all online trading exchange embodiments, bid/offer matches involving a time and/or event variant, such as a binary forex index or sporting match, instantly trigger payments as well. In this case, however, payments from both the bid and offer parties are sent to temporary funds on client-side applications residing either at each party's computer, the payment processor, or designated storage locations accessible by both parties and the payment processor. The funds are unavailable to either party until the close of the event. Upon the determination of a winning side, a payment is instantly triggered, reversing the original payment made by the winning bid/offer party.

For the sake of brevity, the following embodiments where a method is either a software module or stand-alone software application which interacts with either an online payment processor and/or an online auction or online trading exchange and/or end-users of an online auction or online trading exchange, it is presumed that all other systems and methods presented earlier involving reserved bids and payments and/or queue bids and payments, are used within the method.

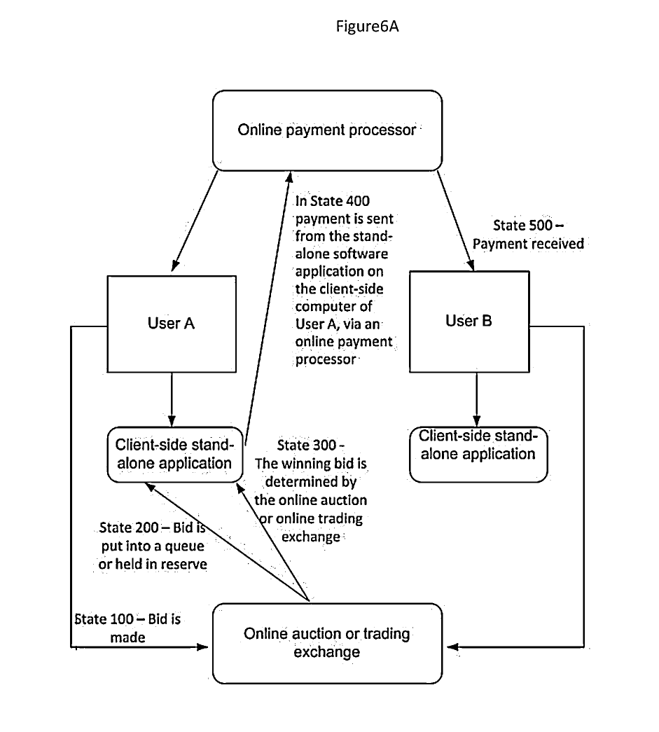

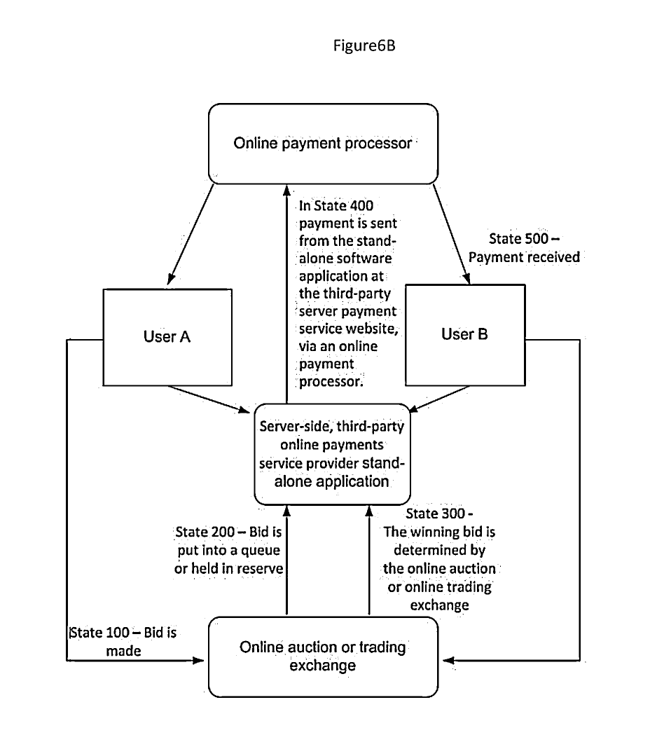

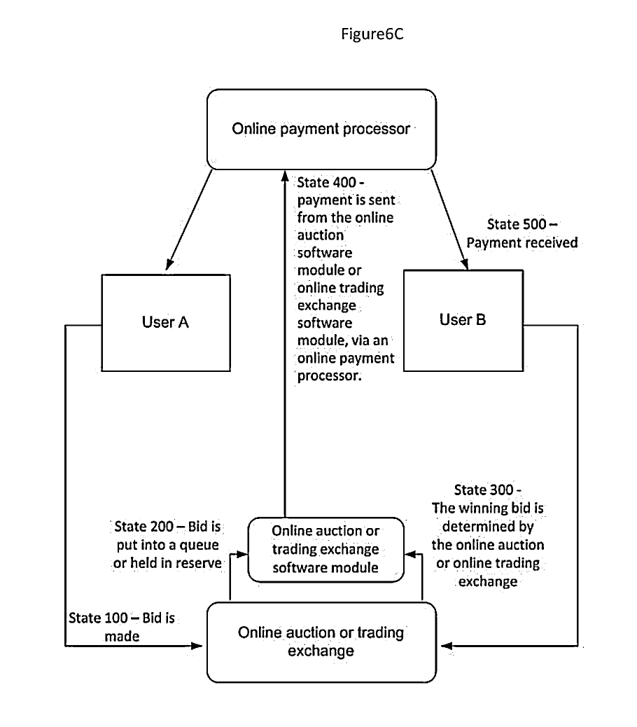

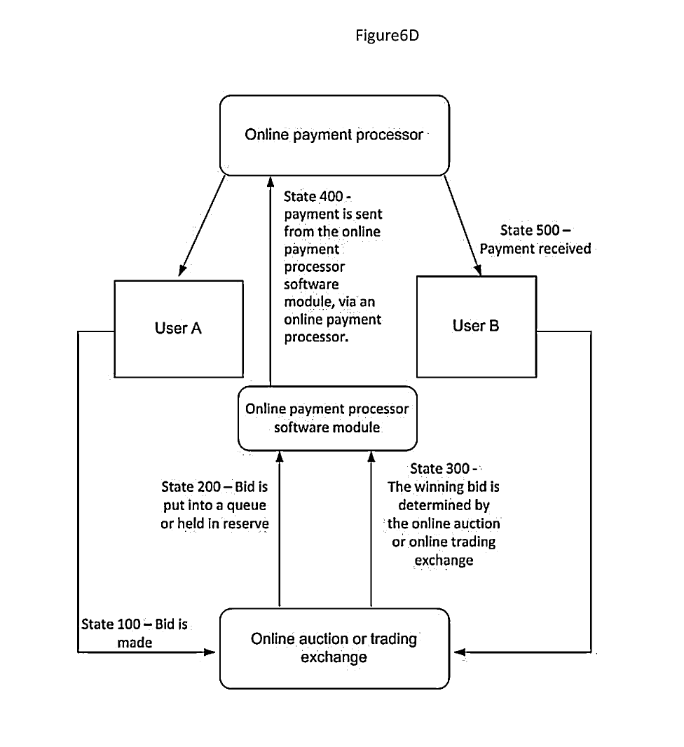

FIG. 6A is a diagram depicting the relationships between an online auction or online trading exchange, an online payment network entity, a consumer(s), and a stand-alone software application which resides either at the client-side computer of an online auction or online trading exchange user, the payment processor, or designated storage locations, and which interacts with an online payment processor and/or an online auction or online trading exchange and/or end-users of an online auction or online trading exchange, that make up a stand-alone software application/entity environment for the invention.

In this embodiment, (FIG. 6A) the user (User A) of an online auction or online trading exchange makes a bid, in State 100. In State 200, either a fund is reserved in the amount of the bid, or the bid is put into a queue, via the stand-alone software application on the client-side computer of User A. The winning bid is determined by the online auction or online trading exchange in State 300. In State 400 payment is sent from the stand-alone software application on the client-side computer of User A, via an online payment processor. In State 500 payment is received by the other user (User B) of the online auction or online trading exchange, via an online payment processor.

FIG. 6B is a diagram depicting the relationships between an online auction or online trading exchange, an online payment network entity, a consumer(s), and a stand-alone software application which resides at the server-side computer of a third-party online payments service provider, which interacts with an online payment processor and/or an online auction or online trading exchange and/or end-users of an online auction or online trading exchange, that make up a stand-alone software application/entity environment for the invention.

In this embodiment, (FIG. 6B) the user (User A) of an online auction or online trading exchange makes a bid, in State 100. In State 200, either a fund is reserved in the amount of the bid, or the bid is put into a queue, via the stand-alone software application at the third-party server payment service website. The winning bid is determined by the online auction or online trading exchange in State 300. In State 400 payment is sent from the stand-alone software application at the third-party server payment service website, via an online payment processor. In State 500 payment is received by the other user (User B) of the online auction or online trading exchange, via an online payment processor.

FIG. 6C is a diagram depicting the relationships between an online auction or online trading exchange, an online payment network entity, a consumer(s), and a software module which resides at the server-side computer of an online auction or online trading exchange, which interacts with an online payment processor and/or an online auction or online trading exchange and/or end-users of an online auction or online trading exchange, that make up a module/entity environment for the invention.

In this embodiment, (FIG. 6C) the user (User A) of an online auction or online trading exchange makes a bid, in State 100. In State 200, either a fund is reserved in the amount of the bid, or the bid is put into a queue, via the server-side online auction or online trading exchange software module. The winning bid is determined by the online auction or online trading exchange in State 300. In State 400 payment is sent from the online auction software module or online trading exchange software module, via an online payment processor. In State 500 payment is received by the other user (User B) of the online auction or online trading exchange, via an online payment processor.

FIG. 6D is a diagram depicting the relationships between an online auction or online trading exchange, an online payment network entity, a consumer(s), and a software module which resides at the server-side computer of an online payment processor, which interacts with an online payment processor and/or an online auction or online trading exchange and/or end-users of an online auction or online trading exchange, that make up a module/entity environment for the invention.

In this embodiment, (FIG. 6D) the user (User A) of an online auction or online trading exchange makes a bid, in State 100. In State 200, either a fund is reserved in the amount of the bid, or the bid is put into a queue, via the server-side online payment processor software module. The winning bid is determined by the online auction or online trading exchange in State 300. In State 400 payment is sent from the online payment processor software module, via an online payment processor. In State 500 payment is received by the other user (User B) of the online auction or online trading exchange, via an online payment processor.

For all embodiments involving the online auction, a method is used where the online payment network API establishes whether shipping is to be either predetermined or variable for each bid. For a variable shipping charge to be included with a bid, the online auction will give the online auction user a choice before confirming a bid. The shipping charge will then be added to the bid.

For all embodiments, the online payment network uses a merchant code in order to identify what online auction or trading exchange is using the online payment network API.

### REFERENCES CITED [REFERENCED BY]

### U.S. Patent Documents

U.S. Pat. No. 7,870,058
Maltzman Jan. 11, 2011
U.S. Pat. No. 8,108,278
Tzekin, et al. Jan. 31, 2012
U.S. Pat. No. 8,224,702
Mengerink, et al. Jul. 17, 2012
U.S. Pat. No. 8,229,855
Huang, et al. Jul. 24, 2012
U.S. Pat. No. 8,239,330
Montero, et al. Aug. 7, 2012

### OTHER REFERENCES

[1] “Online auctions: An in-depth look”. National Consumers League, date unknown, downloaded from http://www.nclnet.org/personal-finance/121-online-auctions/279online-auctions-an-in-depth-look on Jun. 15, 2012.
[2] Ina Steiner. “Deadbeat Bidders Comprise 10% of eBay Unit Sales”. Ecommercebytes, Jan. 29, 2008, downloaded from http://www.ecommercebytes.com/cab/abn/y08/m01/i29/s02 on Jun. 10, 2012, 1 page.
[3] Bob Sullivan. “'Deadbeat bidders' dog eBay sellers—Auction winners who don't pay up are a growing trend”. MSNBC, Sep. 5, 2002, downloaded from http://www.msnbc.msn.com/id/3078738/ns/technology_and_sciencetech_and_gadgets/t/deadbeat-bidders-dog-ebay-sellers/#.UCVN1qD61qB on Jun. 12, 2012.
[4] Ina Steiner. “eBay Mulls New Feature to Eliminate Deadbeat Bidders”. Ecommercebytes, May 12 2012, downloaded from http://www.ecommercebytes.com/C/blog/blog.pl?/pl/2012/5/1336831866.html on Jun. 10, 2012, 1 page.

1. A system to process online monetary payments between end-users, to be an online payment processor application, which is comprised of software that which communicates between an end-user(s) and a transaction server; the communication being directly between an end-user and one or more other end-users; said payments of one or more end-users, to first consist of bids/offers in an online auction, online trading exchange, or a numerical amount in an online environment requiring specialized person-to-person and/or time contingent payment processing; said bids/offers/numerical amount to be backed by actual funds, held in reserve, or said bids/offers/numerical amount to be held in a queue; said bids/offers/numerical amount to involve conditional triggers on future events, such as winning bids/offers in an online auction or online trading exchange, or numerical amounts in another online environment; said bids/offers to be authorized as payment only upon finalization of an event, and determination of highest or a winning bid/offer or other event finalization; said bids/offers and payments to be optionally encrypted using digital certificates to authenticate each bid/offer and payment transaction.

2. The system recited in claim 1 is used, in which bids/offers or other numerical amounts are to be held in a queue, and wherein the software interacts with bank person-to-person online payment processors or debit/credit card payment processors, either as a plug-in software module or stand- alone software application.

3. The system recited in claim 1 is used, in which bids/offers or other numerical amounts are to be to be held in a queue, and wherein the software interacts with automated clearing house online payment processors, either as a plug-in software module or stand-alone software application.

4. The system recited in claim 1 is used, in which bids/offers or other numerical amounts are to be backed by actual funds, held in reserve, or held in a queue, and wherein the software interacts with e-currency online payment processors, either as a plug-in software module or stand-alone software application.

5. The system recited in claim 1 is used, in which bids/offers or other numerical amounts are to be backed by actual funds, held in reserve, and wherein the software interacts with bank person-to-person online payment processors or debit/credit card payment processors, either as a plug-in software module or stand-alone software application.

6. The system recited in claim 1 is used, in which bids/offers or other numerical amounts are to be backed by actual funds, held in reserve, and wherein the software interacts with automated clearing house online payment processors, either as a plug-in software module or stand-alone software application.

7. A system, to be comprised of software, that which is an online auction which communicates between an end-user(s) and a transaction server; using that which uses a bidding process, and processes online monetary payments between end-users via any available online payment processors; said bidding process is linked with online payment processors, so that bids or offers are backed by actual funds, held in reserve said payments of one or more end-users, to first consist of bids/offers in an online auction; said bids or offers to be backed by actual funds, held in reserve, or said bids or offers to be held in a queue; said bids/offers to involve conditional triggers on future events, such as winning bids/offers in an online auction; said bids/offers to be authorized as payment only upon finalization of an event, and determination of highest or a winning bid/offer; said bids/offers and payments to be optionally encrypted using digital certificates to authenticate each bid/offer and payment transaction.

8. The system recited in claim 7 is used, in which bids or offers are to be backed by actual funds, held in reserve, and wherein the software interacts with online auctions and bank person-to-person online payment processors or debit/credit card payment processors, either as a plug-in software module or stand-alone software application.

9. The system recited in claim 7 is used, in which bids or offers are to be backed by actual funds, held in reserve, and wherein the software interacts with online auctions and automated clearing house online payment processors, either as a plug-in software module or stand-alone software application.

10. The system recited in claim 7 is used, in which bids or offers are to be backed by actual funds, held in reserve, and wherein the software interacts with online auctions and e-currency online payment processors, either as a plug-in software module or stand-alone software application.

11. The system recited in claim 7 is used, in which bids or offers are to be held in a queue, and wherein the software interacts with online auctions and bank person-to-person online payment processors or debit/credit card payment processors, either as a plug-in software module or stand-alone software application.

12. The system recited in claim 7 is used, in which bids or offers are to be held in a queue, and wherein the software interacts with online auctions and automated clearing house online payment processors, either as a plug-in software module or stand-alone software application.

13. The system recited in claim 7 is used, in which bids or offers are to be held in a queue, and wherein the software interacts with online auctions and e-currency online payment processors, either as a plug-in software module or stand-alone software application.

14. A system, to be comprised of software, that which is an online trading exchange, and is either a stock exchange, commodity exchange, foreign exchange, sporting exchange, gaming exchange, file sharing exchange, or another person-to-person exchange, that which uses a bid/offer process, and processes online monetary payments between end-users via any available online payment processors, which is comprised of software that which communicates between an end-user(s) and a transaction server; said payments of one or more end-users, to first consist of bids/offers in an online trading exchange; said bids/offers to be backed by actual funds, held in reserve, or said bids/offers to be held in a queue; said bids/offers to involve conditional triggers on future events, such as winning bids/offers in an online trading exchange; said bids/offers to be authorized as payment only upon finalization of an event, and determination of highest or winning bid/offer; said payments from both the bid and offer parties to be sent to a temporary funds in a client-side application residing on each party's computer; said funds to be unavailable to either party until the end of the event; with determination of a winning side, payment to be instantly triggered, reversing the original payment made by the winning bid/offer party; said bids/offers and payments to be optionally encrypted using digital certificates to authenticate each bid/offer and payment transaction.

15. The system recited in claim 14 is used, in which bids or offers are to be backed by actual funds, held in reserve, and wherein the software interacts with online trading exchanges, and bank person-to-person online payment processors or debit/credit card payment processors, either as a plug-in software module or stand-alone software application.

16. The system recited in claim 14 is used, in which bids or offers are to be backed by actual funds, held in reserve, and wherein the software interacts with online trading exchanges, and automated clearing house online payment processors, either as a plug-in software module or stand-alone software application.

17. The system recited in claim 14 is used, in which bids or offers are to be backed by actual funds, held in reserve, and wherein the software interacts with online trading exchanges, and e-currency online payment processors, either as a plug-in software module or stand-alone software application.

18. The system recited in claim 14 is used, in which bids or offers are to be held in a queue, and wherein the software interacts with online trading exchanges, and bank person-to-person online payment processors or debit/credit card payment processors, either as a plug-in software module or stand-alone software application.

19. The system recited in claim 14 is used, in which bids or offers are to be held in a queue, and wherein the software interacts with online trading exchanges, and automated clearing house online payment processors, either as a plug-in software module or stand-alone software application.

20. The system recited in claim 14 is used, in which bids or offers are to be held in a queue, and wherein the software interacts with online trading exchanges, and e-currency online payment processors, either as a plug-in software module or stand-alone software application.
